(19) United States
(12) Patent Application Publication
(10) Pub. No.: US 2026/0326487 A1
(43) Pub. Date: Oct. 22, 2026

(54) Locking Device and Methods of Use

(71) Applicant: PG Legacy Locks, LLC, LUBBOCK, TX (US)

(72) Inventor: Patrick Thomas Green, Lubbock, TX (US)

(21) Appl. No.: 19/651,315

(22) Filed: Apr. 17, 2026

Related U.S. Application Data
(60) Provisional application No. 63/790,175, filed on Apr. 17, 2025.

(51) Int. Cl. B60D 1/60

(52) U.S. Cl. CPC B60D 1/60

(57) ABSTRACT

A locking device for securing a trailer includes a body defining an interior space configured to receive at least a portion of a trailer coupler and one or more trailer safety chains. The body includes portions movable relative to one another between an open position and a closed position, and one or more locking mechanisms configured to secure the body in the closed position. When secured, the body encloses the trailer coupler and safety chains to inhibit access and reduce the likelihood of unauthorized removal or towing of the trailer. In certain embodiments, the locking device includes an internal engagement member positioned within the interior space and configured to engage the trailer coupler. The locking mechanisms may include one or more locks positioned along the body and cooperating with protective structures configured to limit access to the locks and resist tampering. The locking device provides a compact and robust structure for securing multiple trailer components within a single enclosure.

### CROSS-REFERENCE TO RELATED APPLICATIONS

This application claims the benefit of U.S. Provisional Application No. 63/790,175, filed Apr. 17, 2025, the entirety of which is incorporated by reference herein.

### BACKGROUND OF THE INVENTION

### 1. Field of the Invention

The present invention generally relates to a locking device, and more specifically relates to a trailer coupler locking device arranged and configured to prevent theft of a trailer.

### 2. Description of Related Art

Trailers, particularly those used to transport valuable cargo (e.g., valuable equipment, tools, recreational vehicles, etc.) are lucrative targets for thieves, and trailer security is a major concern for owners and operators. Trailers are often left unattended for extended periods of time in parking lots, storage lots, roadside parking areas, at job sites, at campsites, etc. The inherent mobility of trailers makes trailers especially vulnerable to theft. Stolen trailers can be resold quickly, often without proper documentation, making them difficult to track and recover.

Conventional trailer security devices are often insufficient to deter determined thieves. Many trailers are secured by a simple hitch latch, which can be broken or bypassed quickly and easily, allowing thieves to unhitch a trailer and hook it up to their own vehicle in a matter of seconds. Most trailers rely on simple hitch latches, coupler locks, or padlock-based systems that are exposed and easily accessible. Such devices can easily be bypassed using common tools (e.g., bolt cutters, pry bars, or cutting implements) or bypassed entirely by manipulating or removing the hitch components. In some cases, thieves may utilize universal keys, lockpicking tools, or other techniques to bypass standard locking mechanisms. Additionally, conventional devices often fail to secure associated components, such as safety chains, which may be used to facilitate unauthorized towing.

Because a trailer can typically be detached and connected to another vehicle in a matter of seconds, even a brief lapse in supervision can result in theft. Existing security solutions generally focus on a single aspect of the trailer, such as the coupler, without fully addressing the need for comprehensive protection of both the coupling interface and associated hardware. As a result, there remains a significant risk of unauthorized removal of a trailer locking device and theft of the trailer.

Accordingly, there exists a need for an improved locking device that provides enhanced security by protecting multiple critical components of a trailer in a unified manner. In particular, there is a need for a device that secures both the trailer coupler and associated safety chains within a protected enclosure, thereby reducing exposure to tampering and limiting access to key connection points.

The present invention addresses these and other deficiencies in the art by providing a trailer coupler locking device arranged and configured to inhibit unauthorized access and theft of a trailer. The disclosed device secures the trailer coupler and associated chains within an enclosed, lockable structure, thereby reducing the likelihood of forced entry, manipulation, or bypass. It is a purpose of the present invention to fulfill this and other needs in the art, which will become more apparent to those skilled in the art upon review of the following disclosure.

In view of the foregoing, it is apparent that a need exists in the art for a trailer coupler locking device that overcomes, mitigates, or otherwise addresses the above-described deficiencies. The present invention is directed to fulfilling these needs, as well as other related objectives, as will be understood from the detailed description and accompanying disclosure.

### OBJECTS AND SUMMARY OF THE INVENTION

It is an object of the present invention to overcome the above-described drawbacks associated with current locking devices for securing trailers. To achieve these and other advantages and in accordance with the purpose of the invention, as embodied and broadly described, the present disclosure describes a trailer coupler locking device and method of use.

It is an object of the present invention to provide an improved locking device for securing a trailer and inhibiting unauthorized removal, towing, or use of the trailer.

In accordance with one aspect of the present disclosure, a locking device is provided that includes a body defining an interior space sized and configured to receive at least a portion of a trailer coupler and one or more trailer safety chains. The body includes portions movable relative to one another between an open position and a closed position, and one or more locking mechanisms configured to secure the body in the closed position. When secured, the trailer coupler and safety chains are enclosed within the body to inhibit access and reduce the likelihood of unauthorized removal of the locking device or towing of the trailer.

In accordance with another aspect of the present disclosure, the locking device may include an internal engagement member positioned within the interior space and configured to engage the trailer coupler. In certain embodiments, the internal engagement member may comprise a hitch ball or other coupling structure configured to interface with the trailer coupler, thereby stabilizing the locking device relative to the trailer and further inhibiting removal of the locking device when secured.

In accordance with a further aspect of the present disclosure, the locking device may include one or more locking mechanisms positioned along the body and one or more protective structures configured to limit access to the locking mechanisms. In certain embodiments, the locking mechanisms may include a pair of locks positioned on opposing sides of the body and cooperating with corresponding structural features, such as brackets or recessed regions, to resist tampering, cutting, prying, or other forced entry techniques.

In some embodiments, the body encloses both the trailer coupler and associated safety chains within a single structure, thereby providing a combined security function that protects multiple connection points of the trailer.

In some embodiments, the body may be generally box-shaped; however, other geometries and structural configurations may be utilized without departing from the scope of the present disclosure. The body may include portions movable relative to one another, such as by a hinge disposed along a front side or other portion of the body, to facilitate movement between an open position and a closed position. In other embodiments, the body portions may be separable, slidably engaged, or otherwise movable without the use of a hinge.

The locking device may further include one or more locking mechanisms configured to secure the body in the closed position, including puck-style locks, padlocks, integrated locking systems, or other suitable securing elements. In certain embodiments, a pair of locks are positioned on opposing sides of the body and cooperate with corresponding structural features to resist tampering, forced entry, or unauthorized access.

The locking device may also include an internal engagement member arranged within the interior space and configured to interface with the trailer coupler, such as by engaging a hitch ball or other coupling structure, and the interior space may be configured to receive and restrict movement of the safety chains, thereby preventing access to or use of the chains while the device is installed.

The disclosed device provides an integrated locking solution by enclosing and protecting multiple trailer components within a single structure, thereby reducing vulnerabilities associated with conventional systems that secure only a single element of the trailer. By limiting access to both the coupling interface and associated hardware, the device enhances resistance to tampering and unauthorized towing or relocation.

Additional features and advantages of the invention will become apparent to those skilled in the art upon review of the following detailed description and accompanying drawings.

These, together with other objects of the invention, along with various features of novelty that characterize the invention, are pointed out with particularity in the claims annexed hereto and forming a part of this disclosure. For a better understanding of the invention, its operating advantages, and the specific objects attained by its uses, reference should be had to the accompanying drawings and descriptive matter in which there is described illustrative embodiments of the invention.

### BRIEF DESCRIPTION OF THE DRAWINGS

The accompanying drawings, which are incorporated in and form a part of the specification, illustrate embodiments of the present invention, and together with the description, serve to explain the principles of the invention. It is to be expressly understood that the drawings are for the purpose of illustration and description only and are not intended as a definition of the limits of the invention. In the drawings:

FIG. 1 is a partial cross-sectional side elevation view of a locking device constructed in accordance with the present disclosure.

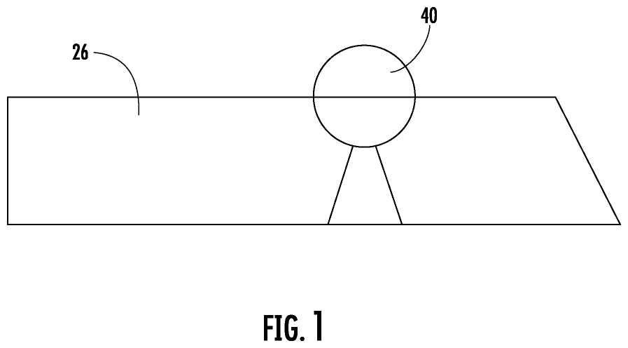

FIG. 2 is a side elevation view of a locking device constructed in accordance with the present disclosure.

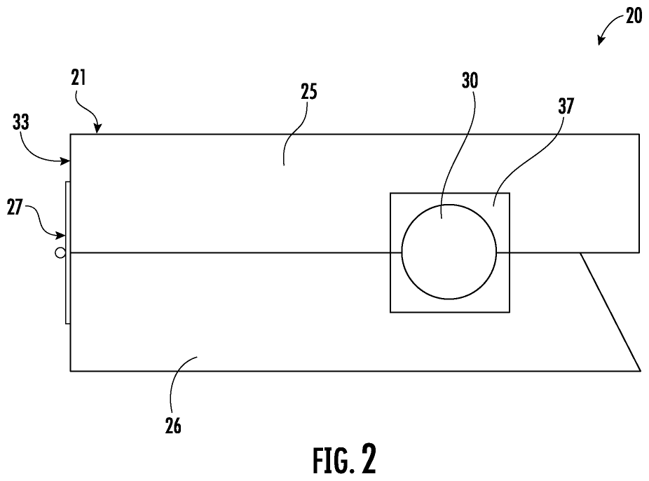

FIG. 3 is a top elevation view of a portion of a locking device constructed in accordance with the present disclosure.

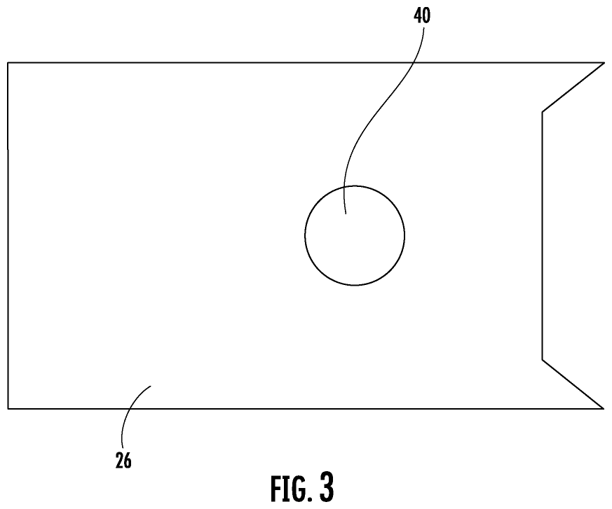

FIG. 4 is a side elevation view of a locking device constructed in accordance with the present disclosure.

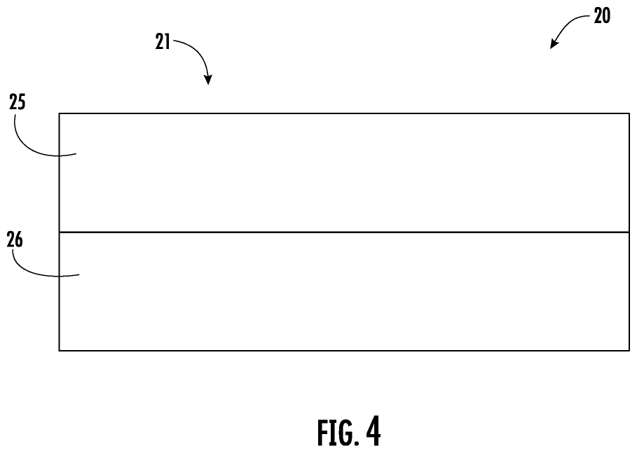

FIG. 5 is a front perspective view of a locking device constructed in accordance with the present disclosure.

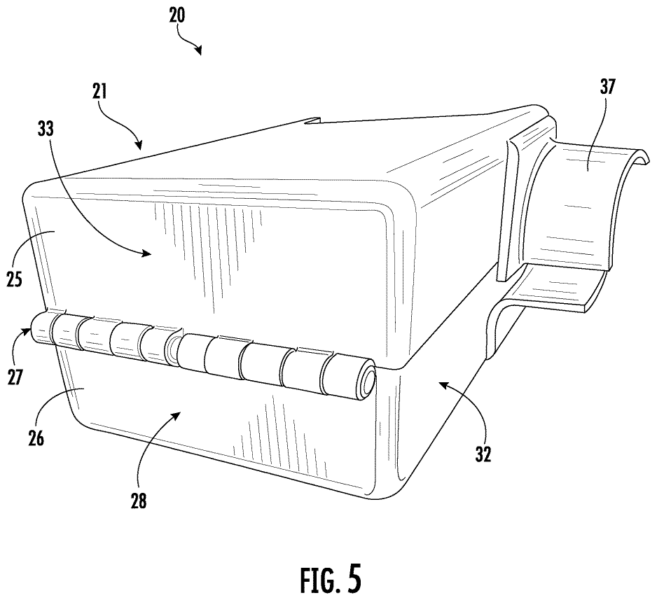

FIG. 6 is a bottom perspective view of a locking device constructed in accordance with the present disclosure.

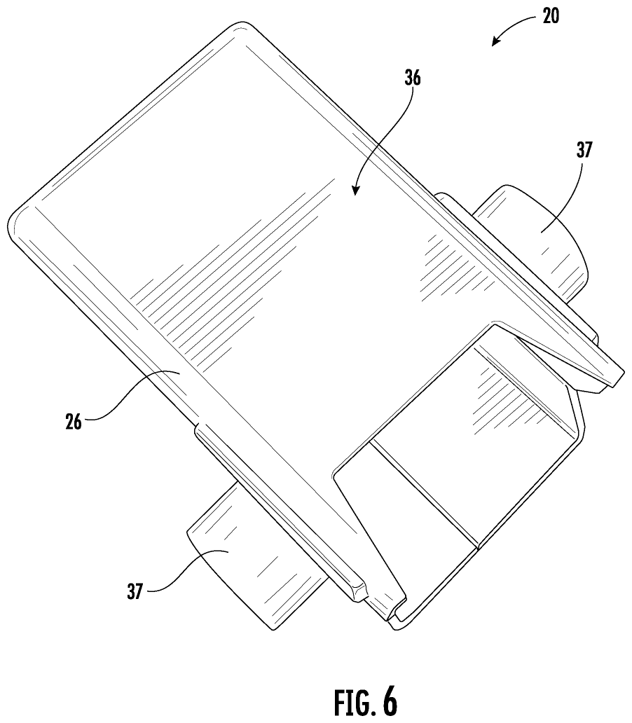

FIG. 7 is a top perspective view of an interior of an open locking device constructed in accordance with the present disclosure.

FIG. 8 is a top perspective view of a closed locking device constructed in accordance with the present disclosure.

FIG. 9 is rear side perspective view of a locking device constructed in accordance with the present disclosure.

FIG. 10 is a top side perspective view of a locking device constructed in accordance with the present disclosure.

FIG. 11 is a rear perspective view of a locking device constructed in accordance with the present disclosure.

FIG. 12 is a partial top side perspective view of a locking device installed on a trailer and constructed in accordance with the present disclosure.

FIG. 13 is a partial rear side perspective view of a locking device installed on a trailer and constructed in accordance with the present disclosure.

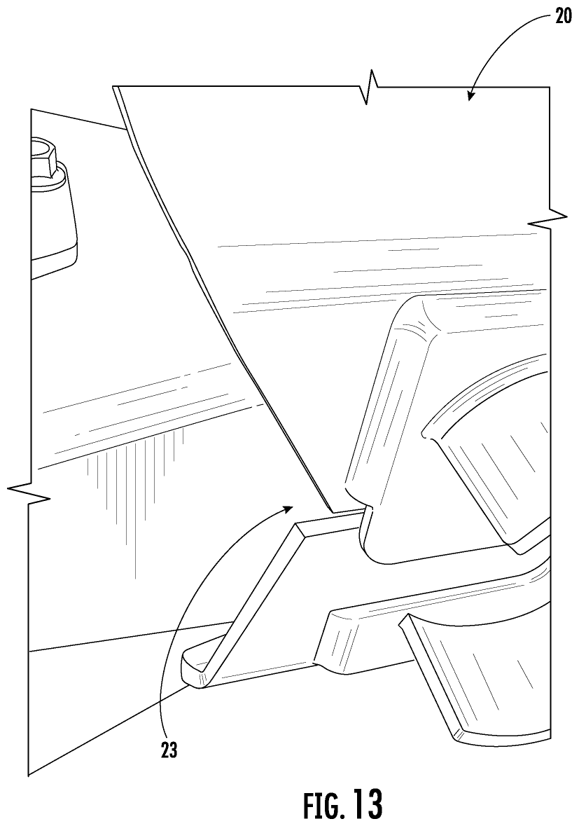

FIG. 14 is a bottom perspective view of a locking device installed on a trailer and constructed in accordance with the present disclosure.

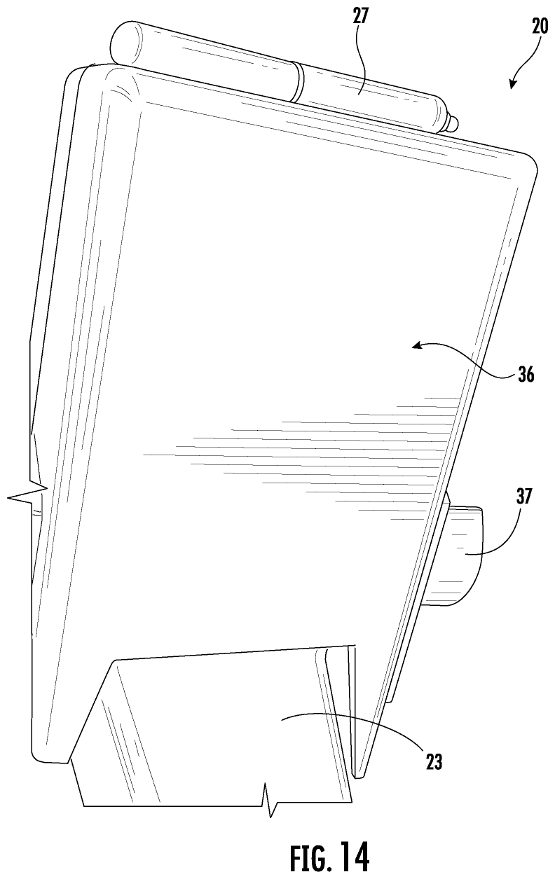

FIG. 15 is a top perspective view of a locking device installed on a trailer and constructed in accordance with the present disclosure.

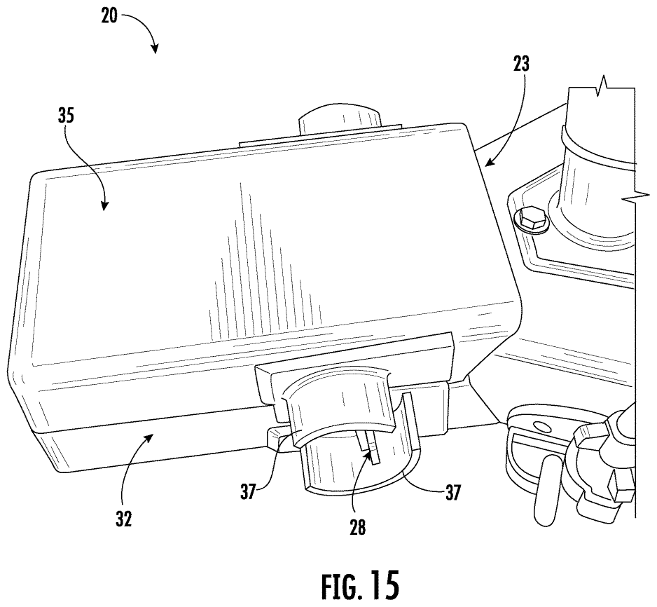

### DETAILED DESCRIPTION OF ILLUSTRATIVE EMBODIMENTS

Exemplary embodiments of trailer coupler locking devices and methods of use in accordance with the present disclosure are discussed below. Many other uses of the present invention will become obvious to one skilled in the art upon acquiring a thorough understanding of the present invention. Once given the below disclosures, many other features, modifications and variations will become apparent to the skilled artisan in view of the teachings set forth herein. Such other features, modifications and variations are, therefore, considered to be a part of this invention.

The disclosed trailer coupler locking device 20 includes a locking system configured to secure a trailer coupler 23 and one or more associated trailer safety chains within a protective enclosure. The locking device 20 comprises a body 21 having an interior space 22 sized and configured to receive at least a portion of the trailer coupler 23 and the trailer safety chains.

In certain embodiments, the body 21 comprises a durable enclosure formed from reinforced steel, aluminum, or other suitable high-strength materials. The enclosure may be generally box-shaped, although other configurations may be utilized without departing from the scope of the present disclosure.

The body 21 may include a first portion 25 and a second portion 26 that are movable relative to one another to facilitate installation of the locking device 20 over the trailer coupler 23. In certain embodiments, a hinge 27 is provided along a front side 33 or other region of the body 21, enabling the first portion 25 to pivot relative to the second portion 26 between an open position and a closed position. The hinged configuration allows access to the interior space 22 during installation and removal of the locking device 20.

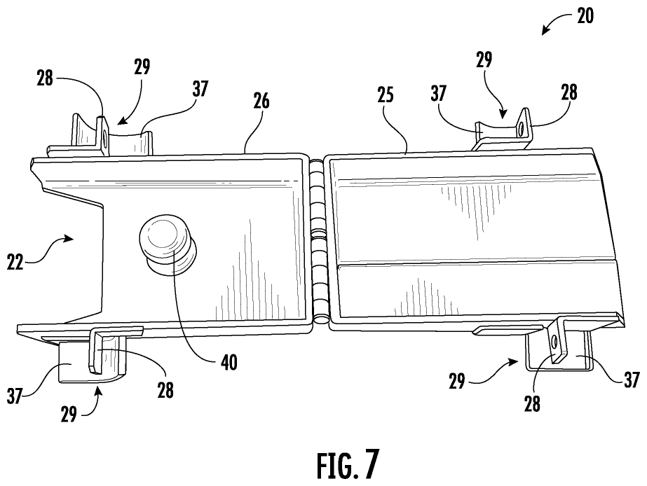

FIG. 7 depicts an interior space 22 that is configured to receive and retain the trailer coupler 23 and associated trailer safety chains, such that the trailer safety chains are enclosed within the body 21 when the locking device 20 is in the closed position, thereby limiting access to the trailer safety chains and inhibiting unauthorized removal of the locking device.

The locking device 20 further includes one or more locking mechanisms 29 configured to secure the body 21 in a closed position once the locking device 20 is installed on the trailer coupler 23. The locks 30 may be positioned along one or more sides of the body 21, including but not limited to the first side 31, second side 32, front side 33, or rear side 34, and may include various types of locks suitable for resisting unauthorized access and removal of the locks. The locks 30 may include puck locks, padlocks, integrated locking mechanisms, or other suitable locking devices.

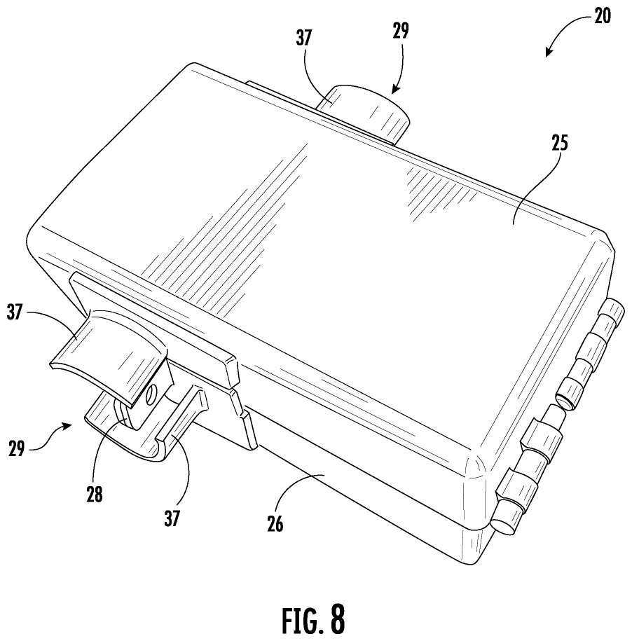

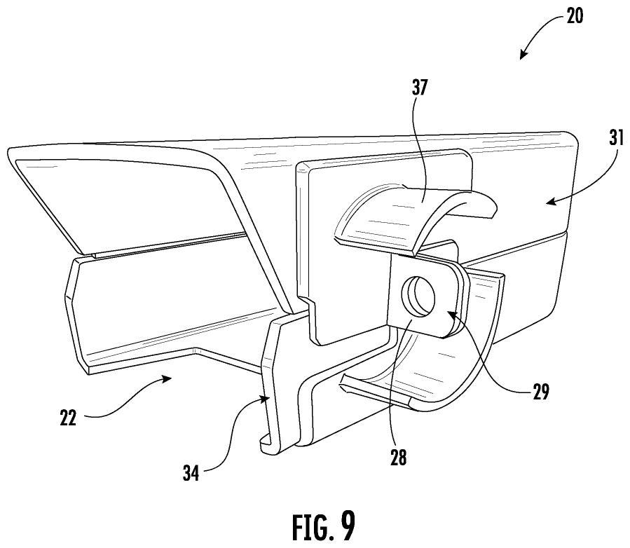

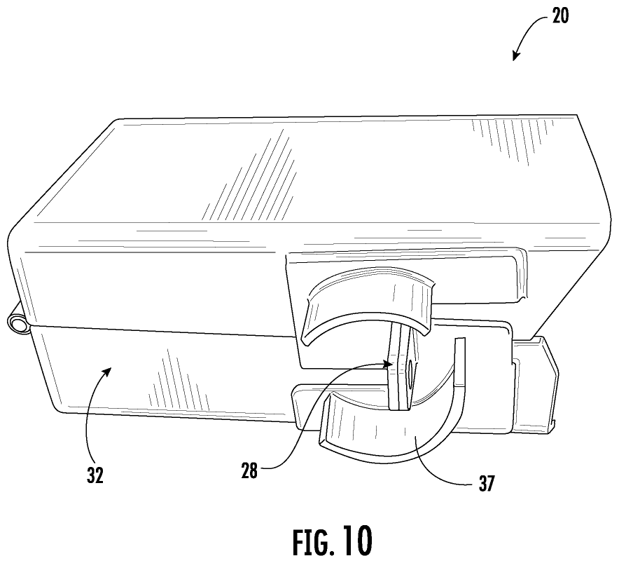

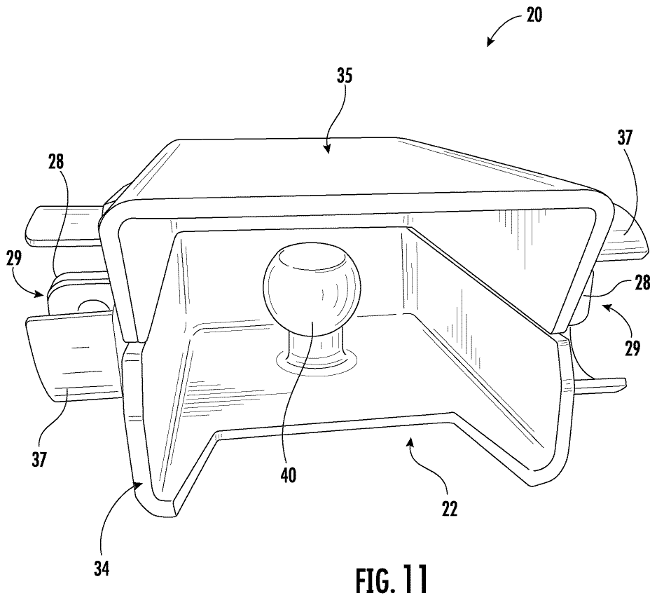

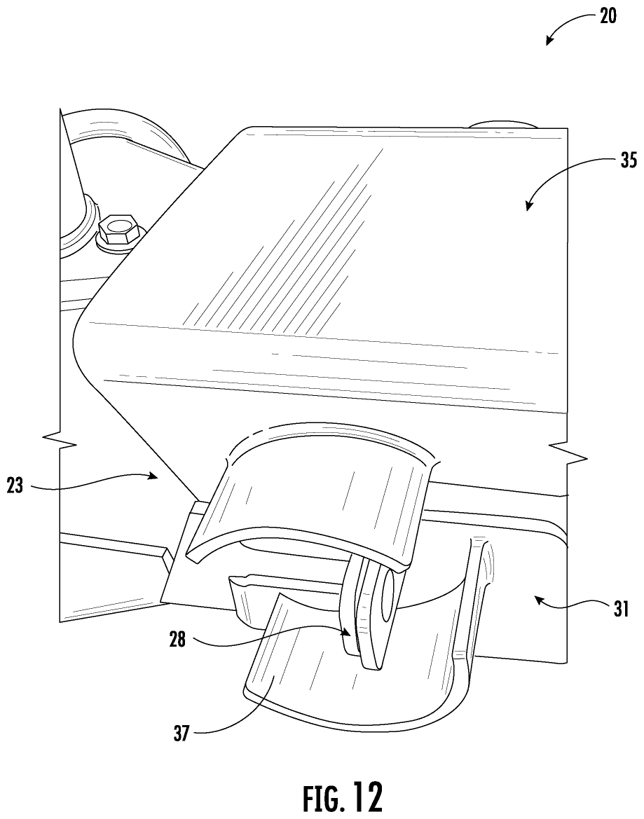

In certain embodiments, the locking mechanisms 29 may be configured to secure the first portion 25 and the second portion 26 of the body 21 together through cooperating structural features. For example, as shown in FIGS. 7-12, each of the first portion 25 and the second portion 26 may include a corresponding locking tab 28, such as an L-shaped bracket or flange, each locking tab 28 comprising an aperture. When the body 21 is in the closed position, the locking tabs 28 may be aligned such that the apertures are substantially aligned with one another (see, e.g., FIGS. 8-12), thereby forming a passage configured to receive a lock 30. The lock 30, which may include a puck lock, padlock, or other suitable lock, may be inserted through the aligned apertures to secure the first portion 25 relative to the second portion 26, thereby maintaining the body 21 in the closed configuration.

It will be appreciated that the locking tabs 28 may take various forms and are not limited to L-shaped structures, and may include tabs, loops, flanges, or other projecting or recessed features configured to align and cooperate when the body 21 is closed. Additionally, the apertures may be replaced or supplemented by slots, openings, or other receiving structures configured to accommodate the lock 30. In some embodiments, multiple sets of locking tabs 28 may be provided at different locations along the body 21, including along the first side 31, second side 32, front side 33, or rear side 34, to provide increased security and resistance to tampering.

In certain embodiments, as illustrated in the drawings, the locking device 20 includes a pair of locking mechanisms 29 positioned on opposing sides of the body 21, such as the first side 31 and the second side 32. The locks 30 may be received within or cooperate with corresponding structural features, such as brackets 37, which may at least partially surround or shield the locks 30. In certain embodiments, the brackets 37 may be generally semi-circular in shape and arranged to limit access to the locks 30, thereby reducing exposure to cutting, drilling, prying, or other tampering methods. The brackets 37 represent one example of a protective structure, and it will be appreciated that other configurations may be utilized to shield or restrict access to the locks 30, including recessed regions, extended walls, guard members, or other structural features. In certain embodiments, the locks 30 may be recessed relative to an exterior surface of the body 21, thereby further limiting access to the locks 30 and reducing exposure to cutting or prying tools.

The locking mechanisms 29 comprising locks 30, locking tabs 28, and associated brackets 37 are arranged and configured to enhance the overall security of the locking device 20 by reinforcing engagement between the first portion 25 and the second portion 26 of the body 21 when in the closed position. The positioning of the locks 30 on opposing sides of the body 21 provides resistance to attack from multiple directions, thereby improving the ability of the locking device 20 to deter unauthorized access or removal.

The locking device 20 is configured to be removably installed onto a trailer coupler 23 using a coupling interface that facilitates secure engagement with a wide range of trailer types. In certain embodiments, the locking device 20 includes an internal engagement member 40 positioned within the interior space 22 of the body 21, the internal engagement member 40 being arranged and configured to interface with the trailer coupler 23.

In certain embodiments, as illustrated in the drawings, the internal engagement member 40 comprises a hitch ball sized and configured to be received within a corresponding socket of the trailer coupler 23, thereby enabling the locking device 20 to be coupled to the trailer coupler 23 in a manner similar to a conventional towing connection. This engagement may assist in stabilizing the locking device 20 relative to the trailer coupler 23 and may inhibit removal of the locking device 20 when the body 21 is in the closed and locked configuration.

It will be appreciated that other types of engagement structures may be utilized in place of or in addition to the hitch ball, including alternative coupling members or interfaces configured to engage different styles of trailer couplers 23. The arrangement of the internal engagement member 40 within the interior space 22 allows the locking device 20 to maintain a compact and robust configuration while providing a secure attachment to the trailer coupler 23.

The overall construction of the locking device 20, including the body 21, locking mechanisms 29, and internal engagement member 40, provides for ease of installation and removal while maintaining a high level of security when the locking device 20 is installed on a trailer coupler 23.

The interior space 22 of the body 21 is further configured to receive and retain one or more trailer safety chains when the locking device 20 is installed on the trailer coupler 23. The trailer safety chains may be positioned within the interior space 22 such that access to the trailer safety chains is restricted when the body 21 is in the closed and locked configuration.

In certain embodiments, the relative positioning of the first portion 25 and the second portion 26 of the body 21 encloses the trailer safety chains within the interior space 22, thereby limiting external access to the trailer safety chains and preventing engagement of the trailer safety chains with an external towing vehicle. The enclosure of the trailer safety chains within the body 21 may also restrict movement of the trailer safety chains, thereby reducing the ability to manipulate or extract the trailer safety chains while the locking device 20 is secured.

The cooperation between the body 21, the locking mechanisms 29, and the enclosed interior space 22 provides a combined security function in which both the trailer coupler 23 and the trailer safety chains are simultaneously protected. By enclosing and restricting access to multiple connection points of the trailer, the locking device 20 reduces vulnerabilities associated with conventional devices that secure only a single component and leave the lock exposed to tampering, cutting, prying, or other forced entry techniques.

It is important to note that the construction and arrangement of the elements of the invention provided herein are illustrative only. Although only a few exemplary embodiments of the present invention have been described in detail in this disclosure, those skilled in the art who review this disclosure will readily appreciate that many modifications are possible in these embodiments (such as variations in orientation of the components of the system, sizes, structures, shapes and proportions of the various components, etc.) without materially departing from the novel teachings and advantages of the invention.

Many other uses of the present invention will become obvious to one skilled in the art upon acquiring a thorough understanding of the present invention. Once given the above disclosures, many other features, modifications and variations will become apparent to the skilled artisan in view of the teachings set forth herein. Such other features, modifications and variations are, therefore, considered to be a part of this invention.

The invention claimed is:

1. A locking device for securing a trailer coupler and a trailer safety chain, comprising:
a body comprising an interior space, the interior space being sized and configured to receive at least a portion of the trailer coupler and the trailer safety chain;
wherein the body includes a first portion and a second portion movable relative to one another between an open position and a closed position; and
one or more locking mechanisms configured to secure the body in the closed position, wherein, when the body is in the closed position and secured by the one or more locking mechanisms, the trailer coupler and the one or more trailer safety chains are enclosed within the interior space to inhibit access to the trailer coupler and the trailer safety chain.

2. The locking device of claim 1, wherein the body comprises an enclosure having a generally box-shaped configuration.

3. The locking device of claim 1, wherein the first portion is hingedly coupled to the second portion.

4. The locking device of claim 1, wherein the one or more locking mechanisms include a pair of locks positioned on opposing sides of the body.

5. The locking device of claim 1, wherein the one or more locking mechanisms include cooperating locking tabs positioned on the first portion and the second portion of the body, the locking tabs being configured to align when the body is in the closed position.

6. The locking device of claim 5, wherein each of the locking tabs comprises an aperture, and wherein the apertures are aligned in the closed position to form a passage configured to receive a lock.

7. The locking device of claim 6, wherein the lock is configured to extend through the aligned apertures to secure the first portion relative to the second portion.

8. The locking device of claim 5, wherein the locking tabs comprise L-shaped brackets.

9. The locking device of claim 5, wherein a plurality of locking tabs are positioned at different locations along the body.

10. The locking device of claim 5, further comprising one or more brackets configured to at least partially surround the locks and configured to limit access to the locks.

11. The locking device of claim 1, further comprising an internal engagement member positioned within the interior space and configured to engage the trailer coupler.

12. The locking device of claim 11, wherein the internal engagement member comprises a hitch ball.

13. A method of securing a trailer having a trailer coupler, comprising:
positioning a locking device over a trailer coupler such that at least a portion of the trailer coupler and one or more trailer safety chains are received within an interior space of the locking device;
moving a first portion of the locking device relative to a second portion of the locking device to place the locking device in a closed position; and
securing the locking device in the closed position using one or more locking mechanisms, wherein the trailer coupler and the one or more trailer safety chains are enclosed within the locking device to inhibit access to the trailer coupler and the one or more trailer safety chains.

14. The method of claim 13, further comprising engaging the locking device with the trailer coupler using an internal engagement member positioned within the interior space.

15. The method of claim 14, wherein the internal engagement member comprises a hitch ball received within a corresponding socket of the trailer coupler.

16. The method of claim 13, wherein securing the locking device includes locking at least one lock positioned along a side of the locking device.

17. The method of claim 13, wherein the one or more trailer safety chains are positioned within the interior space such that movement of the trailer safety chains is restricted when the locking device is in the closed position.

18. A locking device for securing a trailer, comprising:
a body configured to engage a trailer coupler; and
at least one locking mechanism disposed on the body and configured to secure the body in a closed configuration, wherein the at least one locking mechanism includes:
at least one lock positioned along a side of the body;
at least one locking tab positioned along a side of the body and comprising an aperture that receives the lock;
at least one protective structure configured to at least partially surround the lock and configured to limit access to the lock;
wherein the at least one lock and the at least one protective structure cooperate to resist tampering with the locking mechanism and inhibit unauthorized removal of the locking device from the trailer coupler.

19. The locking device of claim 20, wherein the at least one protective structure comprises one or more semi-circular brackets configured to at least partially surround the at least one lock.

20. The locking device of claim 18, wherein the at least one lock is recessed relative to an exterior surface of the body.
